(19) United States
(12) Patent Application Publication
(10) Pub. No.: US 2004/0188884 A1
(43) Pub. Date: Sep. 30, 2004

(54) Forming method of a rubber layer covering the metallic handle of a pneumatic tool

(75) Inventor: Hsiu-Tsu Wang Lin, Da-Li City (TW)

Correspondence Address: TROXELL LAW OFFICE PLLC, SUITE 1404, 5205 LEESBURG PIKE, FALLS CHURCH, VA, 22041, US

(73) Assignee: Master Air Tool Corp.

(21) Appl. No.: 10/394,040

(22) Filed: Mar. 24, 2003

(51) Int. Cl. B29C 45/14

(52) U.S. Cl. 264/265; 264/275; 264/279

(57) ABSTRACT

A forming method of a rubber layer covering the metallic handle of a pneumatic tool includes the following steps: providing a support rod in the opposite openings of the hollow metallic handle of a pneumatic tool, coating rubber metallic bonding agent on the outer surface of the handle, placing the handle coated with bonding agent into a mold, injecting melted rubber into the mold to be molded in shape and finally opening the mold and taking out the handle with a rubber layer thereon.

### BACKGROUND OF THE INVENTION

This invention relates to a method of producing parts of a pneumatic tool, particularly to one of forming a rubber layer covering the metallic handle of a pneumatic tool.

The handle of a conventional pneumatic tool is made of metal so it is strong and enduring in use, but it is easy to slip off a user's hand and give rise to an accident due to its smooth surface, especially when the pneumatic tool is being operated to cause much vibration. Besides, a metallic handle is likely to give rise to electric shock because it conducts electricity well, and let a user feel uncomfortable in holding it as it also conducts heat to render its surface become cold owing to flowing of compressed air.

To eliminate the above-mentioned defects of the handle of the conventional pneumatic tool, a rubber protective sleeve 2 is employed to fit around the metallic handle 1, as shown in FIG. 1. However, the elastic rubber protective sleeve 2 cannot be easily mounted on the metallic handle 1, because the metallic handle is not of a straight tubular shape and has a projecting trigger as well as an air-intake device provided thereon. In some cases, a rubber protective sleeve 2 is made into a comparatively large size in order to be easily fitted around the metallic handle 1, but this may result in lack of tightness between them, easy to slip off. Besides, the rubber protective sleeve 2 and the metallic handle 1 are produced separately, taking too much time and labor in producing and increasing producing cost.

### SUMMARY OF THE INVENTION

The objective of the invention is to offer a forming method of a rubber layer covering the metallic handle of a pneumatic tool, easy in producing, low in cost and having tense tightness.

The steps of forming a rubber layer covering the metallic handle of a pneumatic tool in the present invention include 1. Proving support rods: The hollow metallic handle of a pneumatic tool has its opposite openings respectively fitted therein with a support rod. 2. Coating a rubber metallic bonding agent: The metallic handle has its outer surface coated with rubber metallic bonding agent. 3. Placing in a mold: The handle coated with bonding agent is held by the support rods and placed in a mold for injecting molding, with a packing space formed between the outer side of the metallic handle and the inner wall of the mold. 4. Injecting molding: Melted rubber is injected into the mold to be molded in shape. 5. Opening the mold and taking out the handle: After the rubber and the mold are cooled, the mold is opened to take out the rubber-coated handle and the support rods are removed from the handle.

### BRIEF DESCRIPTION OF DRAWINGS

This invention will be better understood by referring to the accompanying drawings, wherein:

FIG. 1 is a perspective view of a conventional pneumatic tool and its handle protective sleeve:

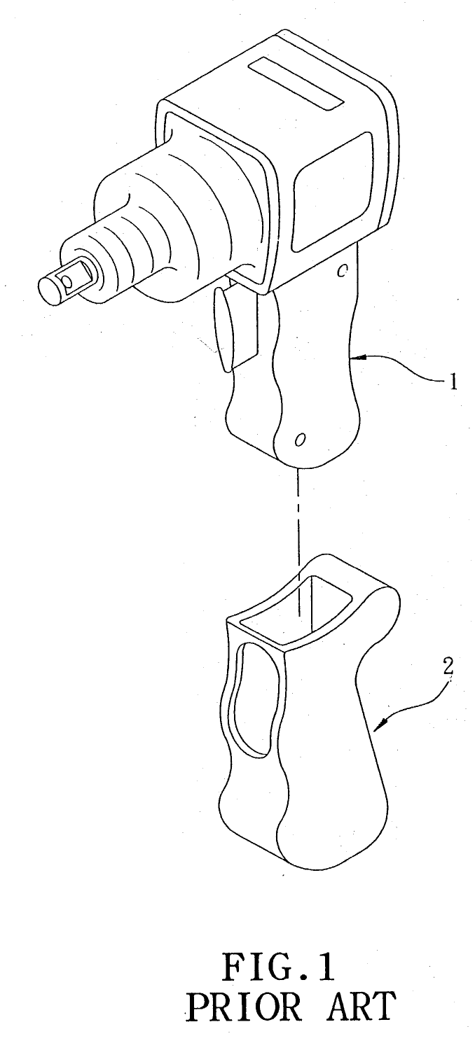

FIG. 2 is front views of a preferred embodiment of the flowing process of forming a rubber layer covering the metallic handle of a pneumatic tool in the present invention:

FIG. 3 is a perspective view of a rubber-coated metallic handle made by the preferred embodiment in the present invention assembled with a pneumatic tool.

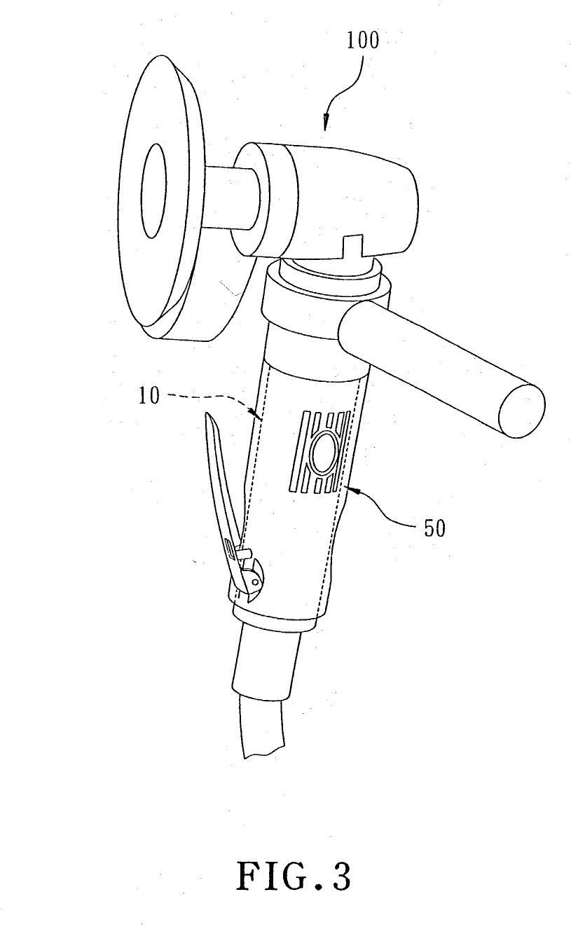

FIG. 4 is a perspective view of a metallic handle made by another preferred embodiment in the present invention; and,

FIG. 5 is a perspective view of a rubber-coated metallic handle made by another preferred embodiment in the present invention.

### DETAILED DESCRIPTION OF THE PREFERRED EMBODIMENT

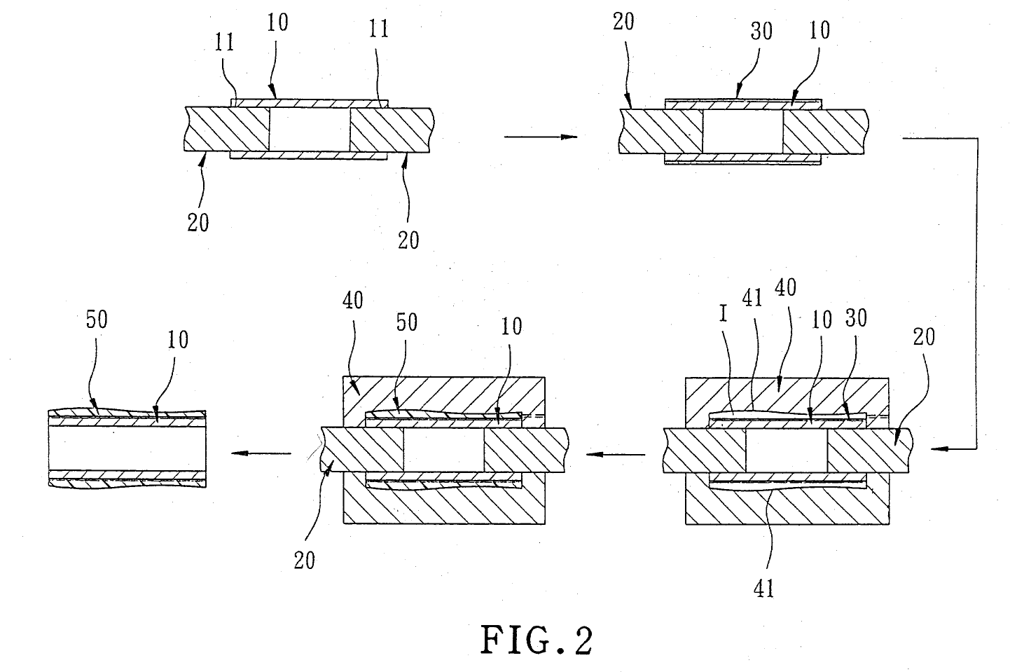

A preferred embodiment of a forming method of a rubber layer covering the metallic handle of a pneumatic tool in the present invention, as shown in FIG. 2, includes the following steps.

1. Providing Support Rods:

Provide the opposite openings 11 of the hollow metallic handle 10 of a pneumatic tool respectively with a support rod 20, with the metallic handle 10 having two opposite openings in this preferred embodiment.

2. Coating Rubber Metallic Bonding Agent:

Coat the surface of the metallic handle 10 a with rubber metallic bonding agent 30.

3. Placed in a Mold:

Place the metallic handle 10 coated with the bonding agent and held by the support rods 20 in a mold 40 for injecting molding, with a packing space 1 formed between the outer side of the metallic handle 10 and the inner wall 41 of the mold 40.

4. Injecting molding:

Inject melted rubber 50 into the packing space 1 in the mold 40 to let the packing space 1 filled up with the melted rubber 50.

5. Opening the Mold and Taking Out the Handle:

After the rubber 50 and the mold 40 are cooled, open the mold 40 and take out the metallic handle 10 coated with the rubber 50 and then remove the support rods 20 from the metallic handle 10.

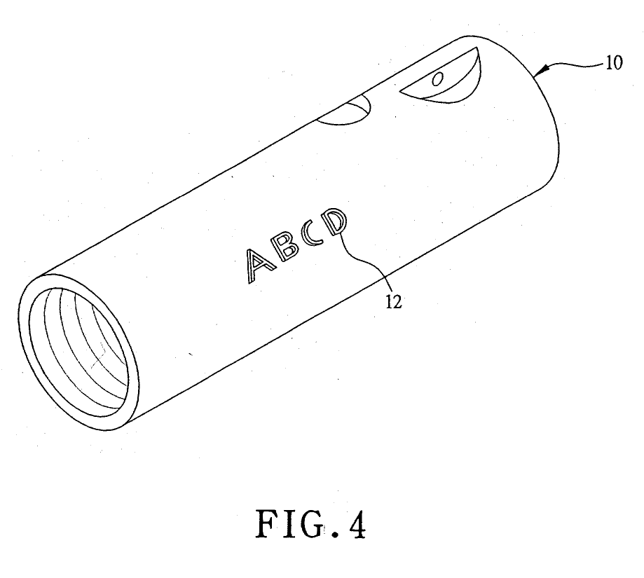

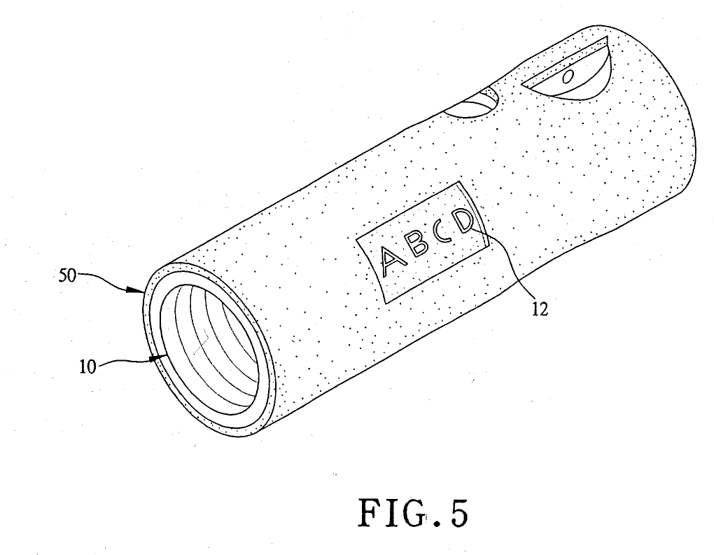

Further, FIGS. 4 and 5 show another preferred embodiment of the invention, in which the metallic handle 10 is formed with a solid boss 12 of a preset height, and the solid boss may be a trademark pattern. When rubber 50 is injected in the mold 40, the rubber may pervade on and around the solid boss 12. Then the rubber 50 located just on the solid boss is removed by polishing, letting the solid boss 12 expose out of the rubber layer 50. Thus, the solid boss 12 of metal material and the surrounding rubber 50 have a stark contrast in their color and material, presenting an effective and obvious impressing of the trademark.

As can be noted from the above description, this invention has the following advantages.

1. It improves the drawbacks of the handle of a conventional pneumatic tool, such as slipping off easily, conducting electricity to cause electric shock and discomfort in holding, and has an effect of shock absorbing as well.

2. The metallic handle 10 is coated with the rubber 50 by injecting molding as soon as it is produced, so the metallic handle 10 and the rubber 50 can contact with each other very closely, impossible to slip off.

3. It is needless to make a rubber sleeve 2 separately, economizing time and labor and lowering producing cost.

4. The mold 40 has its inner wall carved thereon with lines, grains and the like, so the surface of the injecting molded rubber 50 is formed with a curved surface, conforming to ergonomics, and formed thereon with grains, trademarks and designs, beautifying its appearance.

While the preferred embodiment of the invention has been described above, it will be recognized and understood that various modifications may be made therein and the appended claims are intended to cover all such modifications that may fall within the spirit and scope of the invention.

I claim:

1. A forming method of a rubber layer covering the metallic handle of a pneumatic tool comprising the following steps:
(1). Providing support rods: Provide the opposite openings of the hollow metallic handle of a pneumatic tool respectively with a support rod:
(2). Coating rubber metallic bonding agent: Coat the outer surface of said metallic handle with a rubber metallic bonding agent:
(3). Placing in a mold: Place said metallic handle held by said support rods in a mold for injecting molding after it is coated with said rubber bonding agent, a packing space formed between the outer surface of said metallic handle and the inner wall of said mold:
(4). Injecting molding: Inject melted rubber into said packing space in said mold: and
(5). Opening said mold and taking out said handle: Open said mold and take out said handle with a rubber layer thereon after said mold and said handle are cooled, and remove support rods from said handle:

2. The forming method of a rubber layer covering the metallic handle of a pneumatic tool as claimed in claim 1, wherein said metallic handle is formed with a solid boss with a preset height, and said solid boss is formed by injecting rubber in the mold to pervade the rubber over and around said solid boss, and the portion of the rubber layer just on the solid boss is removed by polishing to let the solid boss expose out of the rubber layer.
